(19) United States
(12) Patent Application Publication
(10) Pub. No.: US 2019/0095122 A1
(43) Pub. Date: Mar. 28, 2019

(54) MEMORY MANAGEMENT SYSTEM, COMPUTING SYSTEM, AND METHODS THEREOF

(71) Applicant: Intel Corporation, Santa Clara, CA (US)

(72) Inventors: Francesc Guim Bernat, Barcelona (ES); Kshitij Doshi, Tempe, AZ (US); Daniel Rivas Barragan, Cologne (DE); Federico Ardanaz, Hillsboro, OR (US); Suraj Prabhakaran, Aachen (DE)

(21) Appl. No.: 15/717,963

(22) Filed: Sep. 28, 2017

(51) Int. Cl. G06F 3/06

(52) U.S. Cl. CPC G06F 3/0647; G06F 3/0683; G06F 3/0604

(57) ABSTRACT

According to various aspects, a computing system may include one or more first memories of a first memory type and one or more second memories of a second memory type different from the first memory type and a memory controller. The memory controller may be configured to receive telemetry data associated with at least one of the one or more first memories and the one or more second memories, execute a data transfer between the one or more first memories and the one or more second memories in a first operation mode of the memory controller, suspend a data transfer between the one or more first memories and the one or more second memories in a second operation mode of the memory controller, and switch between the first operation mode and the second operation mode based on the telemetry data.

### TECHNICAL FIELD

Various aspects relate generally to a memory management system, a computing system and methods thereof.

### BACKGROUND

Efficient memory management techniques may become more and more important as performance and data rates increase in computing architectures. In some applications, a paging scheme may be implemented in a computing system. The computer system may include a memory management that allows storing and retrieving data from a secondary storage device, e.g., a hard disk drive (HDD), for use in a main memory, e.g., a random access memory (RAM). There may be various modifications of a memory management including paging. In some applications, paging may be used to implement a virtual main memory in an operating system of a computing system. There, a virtual address space (also referred to as logical address space) may be provided addressing a virtual main memory, wherein the virtual address space is greater than the physical address space of the actually available physical main memory. By flushing and retrieving for example pre-defined pages between the physical main memory and the secondary storage device, applications executed in the operating system may use a virtual main memory having a greater volume than the volume of the actually available physical main memory.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating aspects of the disclosure.

In the following description, some aspects of the disclosure are described with reference to the following drawings, in which:

FIG. 1 shows an exemplary computing system;

FIG. 2 shows an exemplary schematic diagram for a pre-cleaning strategy;

FIG. 3 shows an exemplary computing system including a memory controller, according to some aspects;

FIG. 4 shows an exemplary computing system including a memory controller, according to some aspects;

FIGS. 5A and 5B show respectively an exemplary computing system including a memory controller, according to some aspects;

FIG. 6 shows an exemplary computing system including a memory controller, according to some aspects;

FIG. 7 shows an exemplary schematic diagram for a pre-cleaning strategy, according to some aspects;

FIG. 8 shows an exemplary a data flow of a computing system, according to some aspects;

FIG. 9 shows an exemplary method of operating a computing system, according to some aspects; and

FIG. 10 shows an exemplary method of operating a memory management system, according to some aspects.

### DESCRIPTION

The following detailed description refers to the accompanying drawings that show, by way of illustration, specific details and aspects in which the disclosure may be practiced. The following detailed description refers to the accompanying drawings that show, by way of illustration, specific details and aspects in which the disclosure may be practiced. These aspects are described in sufficient detail to enable those skilled in the art to practice the disclosure. Other aspects may be utilized and structural, logical, and electrical changes may be made without departing from the scope of the disclosure. The various aspects are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures.

One or more aspects are described in sufficient detail to enable those skilled in the art to practice the disclosure. Other aspects may be utilized and structural, logical, and/or electrical changes may be made without departing from the scope of the disclosure.

The various aspects of the disclosure are not necessarily mutually exclusive, as some aspects can be combined with one or more other aspects to form new aspects.

Various aspects are described in connection with methods and various aspects are described in connection with devices. However, it may be understood that aspects described in connection with methods may similarly apply to the devices, and vice versa.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and the claims expressly refer to a quantity greater than one. Accordingly, any phrases explicitly invoking the aforementioned words (e.g., “a plurality of [objects],” “multiple [objects]”) referring to a quantity of objects expressly refers more than one of the said objects. The terms “group (of),” “set [of],” “collection (of),” “series (of),” “sequence (of),” “grouping (of),” etc., and the like in the description and in the claims, if any, refer to a quantity equal to or greater than one, i.e. one or more.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

The terms “processor” or “controller” as, for example, used herein may be understood as any kind of entity that allows handling data. The data may be handled according to one or more specific functions executed by the processor or controller. Further, a processor or controller as used herein may be understood as any kind of circuit, e.g., any kind of analog or digital circuit. The term “handle” or “handling” as for example used herein referring to data handling, file handling or request handling may be understood as any kind of operation, e.g., an I/O operation, and/or any kind of logic operation. An I/O operation may include, for example, storing (also referred to as writing) and reading.

A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

Differences between software and hardware implemented data handling may blur. A processor, controller, and/or circuit detailed herein may be implemented in software, hardware and/or as hybrid implementation including software and hardware.

The term “system” (e.g., a computing system, a memory system, a storage system, etc.) detailed herein may be understood as a set of interacting elements, wherein the elements can be, by way of example and not of limitation, one or more mechanical components, one or more electrical components, one or more instructions (e.g., encoded in storage media), and/or one or more processors, and the like.

The term “storage” (e.g., a storage device, a primary storage, etc.) detailed herein may be understood to include any suitable type of memory or memory device, e.g., a hard disk drive (HDD), and the like.

As used herein, the term “memory”, “memory device”, and the like may be understood as a non-transitory computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™ technology, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

A volatile memory may be a storage medium that requires power to maintain the state of data stored by the medium. Non-limiting examples of volatile memory may include various types of RAM, such as dynamic random access memory (DRAM) or static random access memory (SRAM). One particular type of DRAM that may be used in a memory module is synchronous dynamic random access memory (SDRAM). In some aspects, DRAM of a memory component may comply with a standard promulgated by Joint Electron Device Engineering Council (JEDEC), such as JESD79F for double data rate (DDR) SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

Various aspects may be applied to any memory device that includes non-volatile memory. In one aspect, the memory device is a block addressable memory device, such as those based on negative-AND (NAND) logic or negative-OR (NOR) logic technologies. A memory may also include future generation nonvolatile devices, such as a 3D XPoint™ technology memory device, or other byte addressable write-in-place nonvolatile memory devices. A 3D XPoint™ technology memory may include a transistor-less stackable cross-point architecture in which memory cells sit at the intersection of word lines and bit lines and are individually addressable and in which bit storage is based on a change in bulk resistance.

According to various embodiments, the term “volatile” and the term “non-volatile” may be used herein, for example, with reference to a memory, a memory cell, a memory device, a storage device, etc., as generally known. These terms may be used to distinguish two different classes of (e.g., computer) memories. A volatile memory may be a memory (e.g., computer memory) that retains the information stored therein only while the memory is powered on, e.g., while the memory cells of the memory are supplied via a supply voltage. In other words, information stored on a volatile memory may be lost immediately or rapidly in the case that no power is provided to the respective memory cells of the volatile memory. A non-volatile memory, in contrast, may be a memory that retains the information stored therein while powered off. In other words, data stored on a non-volatile memory may be preserved even in the case that no power is provided to the respective memory cells of the non-volatile memory. Illustratively, non-volatile memories may be used for a long-term persistent storage of information stored therein, e.g., over one or more years or more than ten years. However, non-volatile memory cells may also be programmed in such a manner that the non-volatile memory cell becomes a volatile memory cell (for example, by means of correspondingly short programming pulses or a correspondingly small energy budget introduced into the respective memory cell during programming).

In some aspects, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magneto resistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The terms memory or memory device may refer to the die itself and/or to a packaged memory product.

The term memory cell, as referred to herein, may be understood as a building block of a (e.g., computer) memory. The memory cell may be an electronic circuit configured to store one or more bits. The one or more bits may be associated to at least two voltage levels that can be set and read out (e.g., a logic 0, a logic 1, or in multi bit memory cells, a combination thereof). A plurality of memory cells of the same memory type may be addressable within a single electronic device, e.g., within a single memory device. Further, there may be hybrid electronic devices (e.g., memory devices) including a plurality of memory cells of the different memory types respectively.

The term page, as referred to herein, may be a pre-defined block (e.g., a physical record). A page, also referred to as memory page, virtual page, etc., may include a sequence of bytes or bits. A page may be a contiguous block of virtual memory, described by a single entry in a corresponding page table. The page may have a fixed-size, also referred to as page-size. Accordingly, a page frame may be a contiguous block of physical memory into which pages may be mapped by an operating system. A transfer of pages between a first memory and a second memory may be referred to as paging. A modified page that have is indicated to be written back to a memory with a higher memory level, as described herein, may be referred to as dirty page.

Various aspects are related to a computing system and a method for operating the computing system. According to various aspects, a performance scaling is including an efficient use of bandwidth. This may be applied to a plurality of tiers of paging, e.g., in emerging server nodes and fabric integrated clusters.

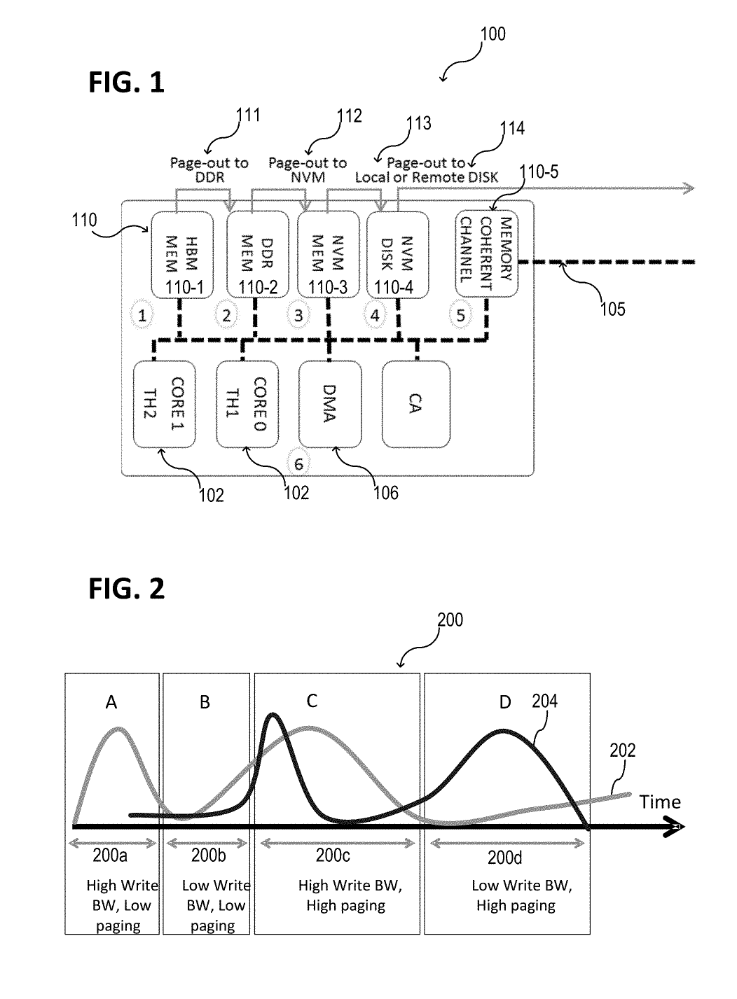

FIG. 1 illustrates exemplarily a computing system 100 in a schematic view. The computing system 100 may include one or more cores. In FIG. 1, two cores 102 are exemplarily illustrated (see core 0, TH1 and core 1, TH2). However, only one core 102 may be used or more than two cores 102 may be used. The one or more cores 102 may operate with several levels (also referred to as tiers) of memory and storage. The computing system 100 may include at least one memory controller 106. The memory controller 106 may be a direct memory access (DMA) and/or a DMA acceleration engine. Direct memory access (DMA) and/or a DMA acceleration engine may allow to access one or more memories of one or more memory levels independently of the one or more cores 102. As an example, an I/O hardware may directly access the memory or storage via the DMA or the DMA acceleration engine. The one or more cores may be for example a central processing unit (CPU) or part of a central processing unit (CPU).

As an example, a memory and storage hierarchy 110 is illustrated in FIG. 1 including five levels of memory and storage. A first level of memory 1 may include one or more high bandwidth memories (HBM) 110-1. A first generation of high bandwidth memory (HBM) may be defined by the JEDEC standard in October 2013. A second generation of high bandwidth memory (HBM) may be defined by the JEDEC standard in January 2016. A second level of memory 2 may include one or more double data rate synchronous dynamic random access memories (DDR-SDRAM, also referred to herein as DDR) 110-2. A third level of memory 3 may include one or more non-volatile memories (NVM) 110-3, e.g., one or more flash based memories, one or more solid-state memories (e.g., one or more solid-state drives, SSD), etc. A fourth level of memory 4 may include one or more further non-volatile memories (NVM) 110-4, e.g., one or more disk memories (e.g., one or more hard disk drives). Further, a fifth level of memory 5 may be used, e.g., including one or more interfaces 110-5 to communicate 105 with one or more remote memories (not illustrated), e.g., with one or more remote storage systems. The one or more interfaces may include any suitable data transfer interface, e.g., a memory coherent channel, Host Fabric Interface (HFI), Omni-Path (OPA), etc.

The one or more remote memories may be available via fabrics such as Omni-Path Architecture (OPA), with paging traffic proceeding through the one or more interfaces 110-5. The one or more interfaces 110-5 may be or may include one or more host interfaces.

As illustrated in FIG. 1, the one or more memories of the different memory levels 1, 2, 3, 4, 5 may provide a memory hierarchy 110 that can be used for paging, also referred to as multi-tiered paging. The page-out of one or more pages may be executed as follows: in 111, one or more pages may be paged out from the first level of memory 1 to the second level of memory 2; in 112, one or more pages may be paged out from the second level of memory 2 to the third level of memory 3; in 113, one or more pages may be paged out from the third level of memory 3 to the fourth level of memory 4; and, for example, in 114, one or more pages may be paged out from the fourth level of memory 4 to the fifth level of memory 5.

The paging scheme illustrated in FIG. 1 is exemplarily shown based on five different memory levels. However, less than five memory levels or more than memory levels may be used. According to various aspects, a pre-cleaning may be carried out to enhance the performance of the paging scheme. According to various aspects, the memory controller 106 may be configured as described for example in more detail below.

In general, an operating system (OS) may periodically write modified pages back to a next tier (usually a drive or a disk) even though they might be further modified in due course. This may be also referred to as pre-cleaning. The pre-cleaning may minimize the amount of work needed to free up page-frames on demand, which may improve responsiveness. In multi-tiered paging, an intensity of pre-cleaning of pages may rise dramatically in the case of irregular accesses (static placement of data not being viable), due to tier migration. However, even in single tiered systems (e.g., today's DRAM architecture) a larger-than-main-memory program (as used for example in scientific, business, and/or industrial applications) may be subjected to a usage of high speed NVM express (NVMe), also referred to as Non-Volatile Memory Host Controller Interface Specification (NVMHCI), drives to back virtual in-memory solutions. Thus pre-cleaning may be important for single or multi-tiered system. Various aspects may be related to an improved pre-cleaning process that may be utilized in a computing system 100 having single or multi-tiered memory.

In general, file pages mapped into a DRAM may be generally pre-cleaned (e.g., via a pdflush daemon) to reduce an amount of updates that may be lost in the case of a crash of the computing system.

FIG. 2 shows a schematic diagram for a general pre-cleaning strategy 200. The horizontal axis represents the time. As an example, four different time segments 200a, 200b, 200c, 200d are indicated. The first curve 202 represents a first load of a first memory (e.g., a volatile memory as for example DDR) in arbitrary units. The first load of the first memory may be caused for example by write operations to the first memory. The first memory may have a first memory level (N). The second curve 204 represents a second load of first memory (e.g., a non-volatile memory as for example SSD or HDD). The second load of the first memory may be caused for example by a page-out of one or more pages from the first memory to a second memory. The second memory may have a second memory level (e.g., N+1 or more) that is higher than the first memory level.

Consider that in a multi-tier memory, upper tiers (e.g., the first memory) may be busy receiving many writes, those pages are dirty and need to be cleaned in anticipation of future recycling, and this cleaning may further consume bandwidth expenditure. As a result, first, the operating system may spend a non-trivial amount of time scanning pages and then issuing requests to a memory controller (e.g., a DMA controller) to perform the write backs, and second, bandwidth demand amplifies in unpredictable ways as illustrated (based on the hypothetical curves 202, 204) in FIG. 2.

In a first time segment 200a, the consumed bandwidth due to the writing may be high and the consumed bandwidth due to the paging may be low. In a second time segment 200b, the consumed bandwidth due to the writing may be low and the consumed bandwidth due to the paging may be low. In a third time segment 200c, the consumed bandwidth due to the writing may be high and the consumed bandwidth due to the paging may be high. In a fourth time segment 200d, the consumed bandwidth due to the writing may be low and the consumed bandwidth due to the paging may be high. As shown in the FIG. 2, in the third time segment 200c, page-outs may taking away memory bandwidth (see curve 204) that applications are contending for as well (see curve 202). However, at another time segment 202b, there is surplus bandwidth that is not utilized.

The challenge for software may be that it can be difficult for the software to detect and/or predict when there is a lull just because some activity hasn't started yet and whether that activity will need memory bandwidth and CPU usage that would be under pressure due to page-outs (i.e. write backs). For example, at another time segment 202a could have been followed by a different time segment 202b during which an application could have generated many memory accesses.

According to various aspects, the system status may be monitored through telemetry data (e.g., including for example performance and/or power). The telemetry data may be already present in the computing system. According to various aspects, the amount of bandwidth and power used may be dynamically adjusted. Therefore, a paging logic (e.g., a smart paging logic SPL) may be used, e.g., implemented into a memory controller (e.g., into a DMA and/or a DMA acceleration engine). The paging logic may be configured to perform the write back in order to clean dirty pages that are potential candidates to be paged-out in the near future in case of a replacement is needed.

In some aspects, a hierarchical storage management (HSM), e.g., a tiered storage management, may be used to move data between different types of storage media. According to some aspects, a tiered storage may be user including two or more types of storage delineated by differences in at least one of these four attributes: price, performance, capacity and function.

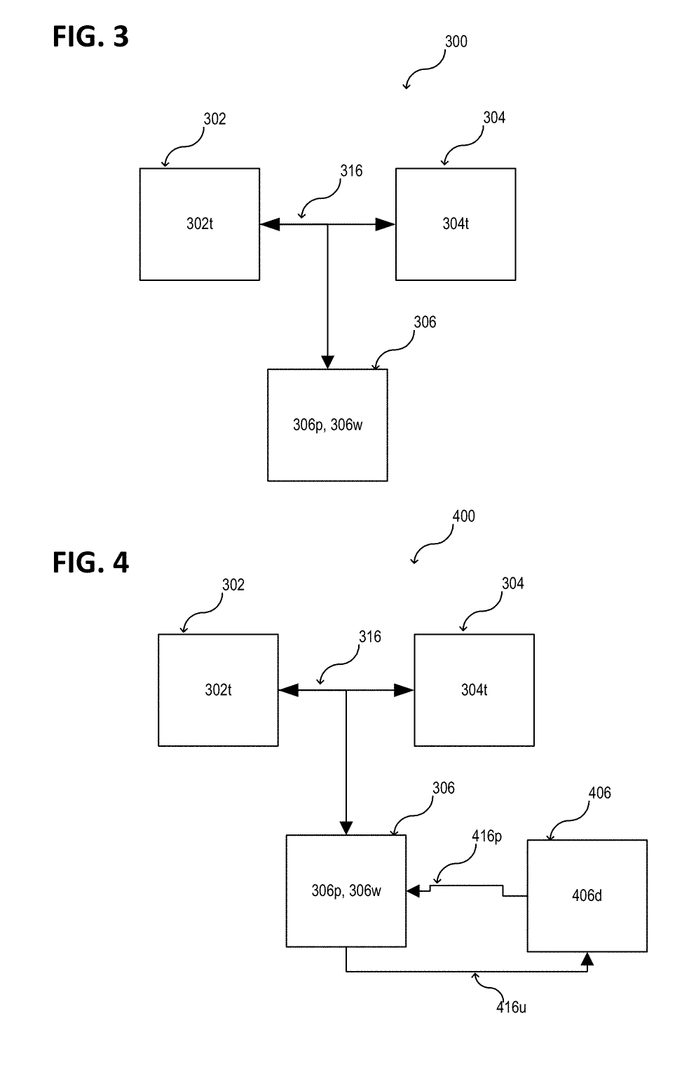

FIG. 3 illustrates a computing system 300 in a schematic view, according to some aspects. The computing system 300 may include one or more first memories 302 of a first memory type 302t. Further, the computing system 300 may include one or more second memories 304 of a second memory type 304t different from the first memory type 302t. According to various aspects, the one or more first memories 302 may include first memory cells of a first memory cell type and the one or more second memories 304 may include second memory cells of a second memory cell type different from the first memory cell type. According to some aspects, the type of memory cells may define the type of memory; however, there may be other characteristics defining various memory types delineated by differences in at least one of price, performance, capacity, and/or function. The computing system 300 may further include a memory controller 306. The memory controller 306 may include a DMA controller and/or a DMA acceleration engine. According to various aspects, the memory controller 306 may include one or more processors or may be a part of one or more processors. According to various aspects, the memory controller 306 may include a paging logic, as described herein. According to various aspects, the memory controller 306 may be configured to control a data transfer 316 between the one or more first memories 302 one or more first memories 302 and the one or more second memories 304. The memory controller 306 may be configured to control a paging, e.g., a page-out from the one or more first memories 302 to the one or more second memories 304.

According to various aspects, the memory controller 306 may be configured to receive telemetry data associated with at least one of the one or more first memories 302 or the one or more second memories 304. The memory controller 306 may be configured to execute the data transfer 316 between the one or more first memories 302 and the one or more second memories 304 in a first operation mode 306p. The memory controller 306 may be configured to suspend the data transfer 316 between the one or more first memories 302 and the one or more second memories 304 in a second operation mode 306w. Further, the memory controller 306 may be configured to switch between the first operation mode 306p and the second operation mode 306w based on the telemetry data.

Illustratively, the memory controller 306 may control the time (e.g., the time segment, see for example FIG. 2) that is used for a data transfer between the one or more first memories and the one or more second memories (e.g., in a first operation mode). This control may include telemetry data, e.g., an available bandwidth for a data transfer 316 between the one or more first memories 302 and the one or more second memories 304. However, other telemetry parameter may be used.

FIG. 4 illustrates a computing system 400 in a schematic view, according to some aspects. The computing system 400 may include the one or more first memories 302, the one or more second memories 304, and/or the memory controller 306, as described above. The computing system 400 may further include a memory management controller 406 configured to execute a memory management and to generate memory management data 406d.

According to some aspects, the memory controller 306 and the memory management controller 406 may be implemented as a single memory controller having the same functions as described herein for the controllers respectively.

According to various aspects, the memory controller 306 may be further configured to receive the memory management data 406d. The memory management data 406d associated with a memory management scheme. As an example, the memory management scheme may include or may be a paging scheme. In this case, the memory management data 406d may include or may be paging data. The paging data may include information indicating one or more dirty pages. As an example, the one or more dirty pages may be indicated via a dirty bit. Illustratively, one or more dirty pages may be evaluated that are to be paged-out from the one or more first memories 302 to the one or more may include memories 304 by the memory controller 306, e.g., when the memory controller 306 is in the first operation mode 306p. Illustratively, the first operation mode 306p may be a paging mode, in which the memory controller 306 executes a pre-cleaning process of the one or more first memories 302. However, the pre-cleaning may be only carried out when the corresponding telemetry data fulfill a pre-defined condition. The pre-defined condition may be for example a low consumed bandwidth for the one or more first memories 302 caused for example by writes from the OS or from other system components.

According to various aspects, the memory controller 306 may be further configured to execute the data transfer based on the received memory management data 406d. The memory management data 406d may be used for example to check for another condition, e.g., to check that the one or more dirty pages may be non-frequently used pages. As an example, only the least recently used (LRU) pages may be paged-out. Therefore, according to various aspects, the paging data provided by the memory management controller 406 may include information indicating one or more least recently used pages, e.g., one or more recently used dirty pages to be paged-out. The data transfer may include a flushing (also referred to as page-out or as write back) of the one or more dirty pages from the one or more first memories to the one or more second memories.

The memory management data 406d may be provided to 416p the memory controller 306. The memory controller may be further configured to update 406u the memory management data 406d associated with the memory management scheme.

According to various aspects, the page directories, page tables, page table entries, and or other data related to the paging scheme may be kept up to date.

According to various aspects, updating the memory management data 406 may include for example changing a dirty bit associated with a page. In other words, the dirty bit may be set to zero again after the page associated with this dirty bit has been paged-out. The clear pages of the one or more first memories 302 may be used to replicate a page from the one or more second memories 304 on demand.

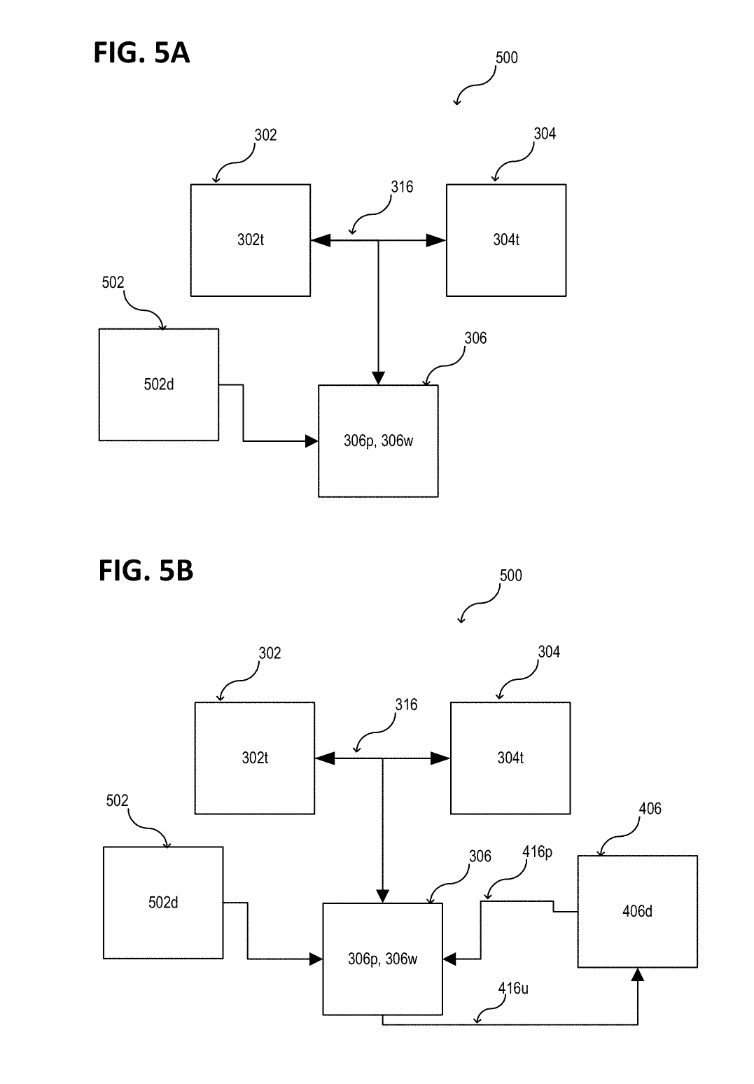

FIG. 5A illustrates a computing system 500 in a schematic view, according to some aspects. The computing system 500 may include the one or more first memories 302, the one or more second memories 304, and/or the memory controller 306, as described above with reference to the computing system 300. FIG. 5B illustrates the computing system 500 optionally including the memory management controller 406, as described above with reference to the computing system 400.

According to various aspects, the computing system 500 may further include one or more processors 502. The one or more processors 502 may be configured to generate the telemetry data 502d for the memory controller 306. According to various aspects, the one or more processors 502 may be a CPU or may be part of a CPU.

According to various aspects, the one or more processors 502 may be for example configured to execute an operating system having access to the one or more first memories 302 and the one or more second memories 304. However, one or more additional processors may be used to execute the operating system.

According to various aspects, the telemetry data 502d may include first bandwidth data associated with the one or more first memories 302. The telemetry data 502d may include, e.g., additionally to the first bandwidth data, second bandwidth data associated with the one or more second memories 304.

According to various aspects, the memory controller 306 may be configured to compare at least one of the first bandwidth data or the second bandwidth data with corresponding bandwidth reference data and, based on the comparison, switch between the first operation mode and the second operation mode. The memory controller 306 may be configured to switch into the first operation mode 306p in the case that at least a predefined fraction of a data bandwidth is available to transfer data between the one or more first memories 302 and the one or more second memories 304. The memory controller 306 may be configured to switch into the second operation mode 306w in the case that at least the predefined fraction of the data bandwidth is not available (see FIG. 8). Illustratively, in the case the a bandwidth of the one or more first memories 302 is consumed by a writing operation (e.g., from OS applications), e.g., the situation that is illustrated in the third time segment 200c of FIG. 2, the memory controller 306 does not perform a page-out, i.e., does not switch or remain in the first operation mode 306p. Instead, the memory controller 306 may perform the page-out for example only in the fourth time segment 200d, when sufficient bandwidth is available for the page-out.

According to various aspects, the telemetry data may include latency data associated with the one or more first memories 302 and/or with the one or more second memories 304.

According to various aspects, the telemetry data 502d may include power data associated with at least one of a load or a power consumption of the one or more processors 502.

According to various aspects, the memory controller 306 may configured to adapt a maximal bandwidth of a data transfer 116 between the one or more first memories 302 and the one or more second memories 304 based on the telemetry data 502d. As any example, if the one or more processors 502 are for example idle or at a low load, the memory controller 306 may cause a power transfer from the one or more processors to the memory controller 306 to increase a maximal bandwidth associated to the data transfer 116 that, at the same time, increases the fraction of available bandwidth assuming that the load remains constant.

In some aspects, the memory controller 306 may be configured to receive an activation information, e.g., from the one or more processors 502, indicating whether or not an activation of the first operation mode 306p is allowed. In other words, the pre-cleaning of the one or more first memories 302 controlled by the memory controller 306 may be activated or deactivated based on the activation information.

According to various aspects, other information, e.g., operation information, may be used to control the page-out via the memory controller 306. Operation information may be associated for example with the switching between the first operation mode and the second operation mode.

According to various aspects, the memory controller 306 may be configured to receive content information associated with the data transfer executed in the first operation mode. As an example, the content information may define a number of pages (e.g., a range of pages or a class of pages, in the case that the pages are classified) to by pre-cleaned via the memory controller 306.

According to various aspects, the memory controller 306 may be configured to execute the data transfer 116 autonomously, e.g., independently from the one or more processors 502 executing the operating system. According to various aspects, the memory controller 306 may execute the data transfer 116 (e.g., the pre-cleaning of the dirty pages) by a direct access to the one or more first memories 302 and the one or more second memories 304.

As an example, the one or more first memories 302 may have a lower memory level than the one or more second memories 304. The one or more first memories 302 may include for example one or more volatile memories. The one or more second memories 304 may include, for example, one or more non-volatile memories. In another configuration, the one or more first memories 302 may include a volatile memory and/or a non-volatile memory and the one or more second memories 304 may be remote storage memories. However, other configurations may be possible, e.g., based on the memory levels 1 to 5 as described with reference to FIG. 1. As an example, the one or more first memories 302 may include one or more volatile memories and the one or more second memories 304 may include one or more volatile memories; or, the one or more first memories 302 may include one or more non-volatile memories and the one or more second memories 304 may include one or more non-volatile memories.

According to various aspects, the one or more first memories 302 may have a first maximal data bandwidth and the one or more second memories 304 may have a second maximal data bandwidth, wherein the first maximal data bandwidth is greater than the second maximal data bandwidth. Illustratively, the one or more first memories 302 may have a higher I/O performance than the one or more second memories 304.

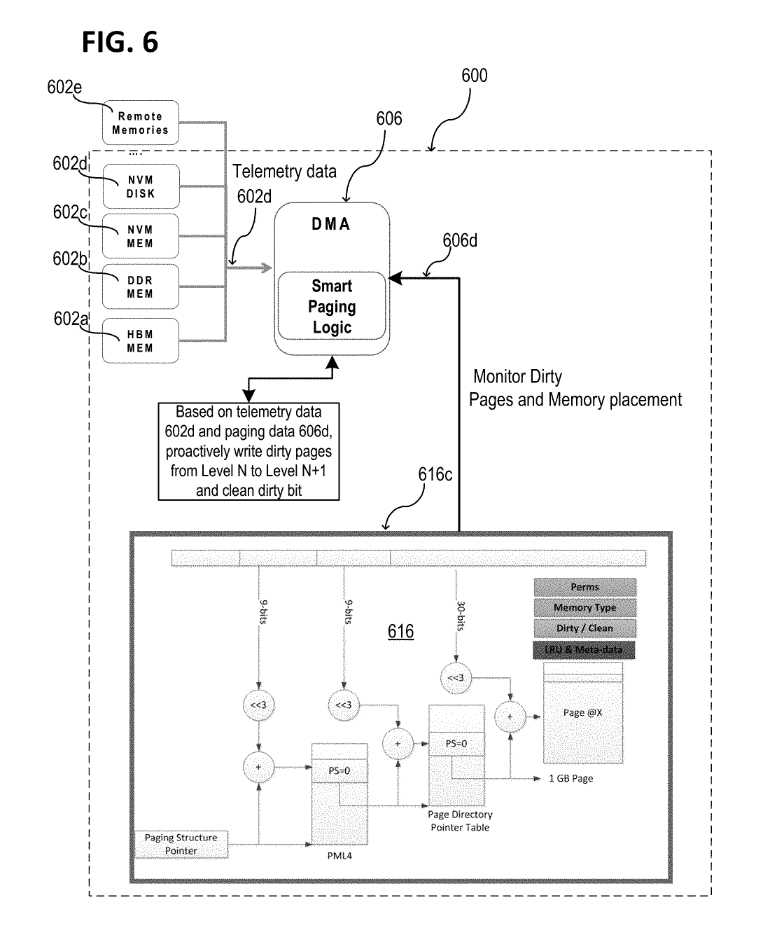

FIG. 6A illustrates a computing system 600 in a schematic view, according to some aspects. The computing system 600 may include, for example, one or more memories of various memory types 602a, 602b, 602c, 602d, 602f. According to various aspects, the computing system 600 may include a memory controller 606. The memory controller 606 may be configured as described above with reference to the computing system 300, 400, 500.

According to various aspects, a paging scheme 616 may be implemented in the computing system 600. In some aspects, the paging scheme 616 may be configured as described above. The computing system 600 may further include a memory management controller 616c configured to execute the paging scheme 616 and to generate paging data 606d. The memory management controller 616c may be configured as described above with reference to FIGS. 4 and 5B. Further, telemetry data 602d may be provided to the memory controller 606.

According to various aspects, based on the telemetry data 602d and the paging data 606d, the memory controller 606 may proactively write dirty pages from a memory of the memory level N to a memory of the memory level N+1 (or higher). Further, the memory controller 606 may clean the dirty bit (e.g., the dirty bit indicating modified pages in the paging scheme 616 may be set to zero). The paging data 606d may include information associated with dirty pages and the corresponding memory placement, etc. The memory controller 606 may monitor the dirty pages, e.g., scan for dirty pages. The telemetry data 602d may include performance data, e.g., bandwidth data, power data, etc.

According to various aspects, the computing system 600 may include one or more high bandwidth memories (HBM) 602a (without loss of generality as a first memory level). The computing system 600 may include one or more DDR memories 602b (without loss of generality as a second memory level). The computing system 600 may include one or more first NVM memories 602c (without loss of generality as a third memory level) and one or more second NVM memories 602d (without loss of generality as a fourth memory level). Further, according to various aspects, the computing system 600 may include one or more remote memories 602e and/or may be coupled with one or more remote memories 602e (without loss of generality as a fifth memory level). However, another number and configuration of the memories may be used if desired.

According to various aspects, one or more first memories of the computing system 600 may have a first maximal data bandwidth and one or more second memories of the computing system 600 may include a second maximal data bandwidth. In this case, the first maximal data bandwidth, e.g., of the HBM memory 602a, may be greater than the second maximal data bandwidth, e.g., of the DDR memory 602b, the NVM memories 602c, 602d, and/or the remote memory 602e, etc. The maximal bandwidth of the memories 602a to 602e may decrease from the HBM memory 602a, to the DDR memory 602b), to the first NVM memory 602c, e.g., an SSD based memory, to the second NVM memory 602d, e.g., a HDD based memory, and finale to the remote memory 602e. Accordingly, different combinations are possible for two or more of the memories 602a to 602e.

According to various aspects, the memory controller 606 may include a logic, e.g., a paging logic (e.g., a smart paging logic, SPL), that works autonomously on every level of the memory hierarchy. The smart paging logic may be implemented into the memory controller 606, e.g., into a DMA controller and/or a DMA acceleration engine. The memory controller 606 may be configured to read and processes page table entry (PTE) structures in page tables. Illustratively, the memory controller 606 may be configured to scan or monitor the paging scheme 616 to extract data that are used to execute, for example, a pre-cleaning of dirty pages.

According to various aspects, the computing system, as described herein, may include or may be any suitable type of computing system, e.g., a storage server, a personal computer, a laptop computer, a tablet computer, an industrial computing system, etc.

According to various aspects, the memory controller, as described herein, may be part of any suitable type of computing system, e.g., a storage server, a remote storage server, a personal computer, a laptop computer, a tablet computer, an industrial computing system, etc.

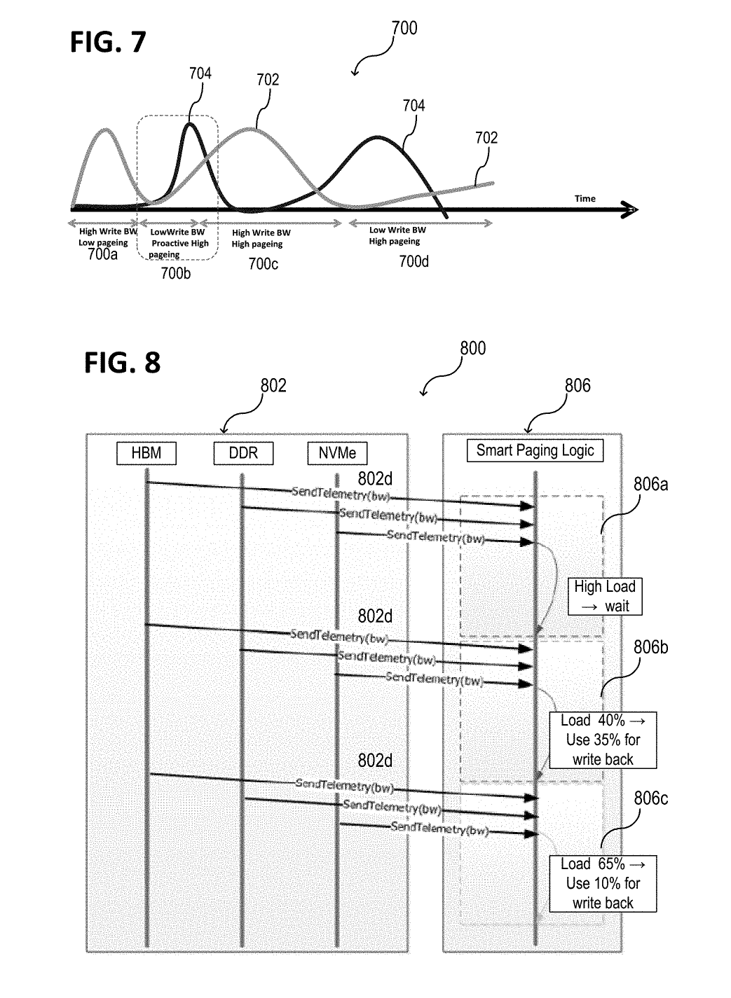

FIG. 7 shows a schematic diagram for a pre-cleaning executed via the memory controller 306, 606 described herein. The horizontal axis represents the time. As an example, four different time segments 700a, 700b, 700c, 700d are indicated (cf. FIG. 2). The first curve 702 represents a first load of a first memory (e.g., a volatile memory as for example DDR 602b) in arbitrary units. The first load of the first memory may be caused for example by write operations to the first memory. The first memory may have a first memory level (N). The second curve 704 represents a second load of first memory (e.g., a non-volatile memory as for example SSD or HDD). The second load of the first memory may be caused for example by a page-out of one or more pages from the first memory to a second memory, as described herein using the smart paging logic. The second memory may have a second memory level (e.g., N+1 or more) that is higher than the first memory level (see FIG. 6).

In a first time segment 700a, the consumed bandwidth due to the writing may be high and the consumed bandwidth due to the paging may be low. In a second time segment 700b, the consumed bandwidth due to the writing (first curve 702) may be low and start rising and the consumed bandwidth due to the paging may rise and fall again upon rising of the first load. In a third time segment 700c, the consumed bandwidth due to the writing may be high again and the consumed bandwidth due to the paging may be low (cf. FIG. 2). In a fourth time segment 700d, the consumed bandwidth due to the writing may be low and the consumed bandwidth due to the paging (second curve 704) may be high. As shown in the FIG. 7, in the third time segment 700c, page-outs may not take away memory bandwidth (see curve 704) that applications are contending for as well (see curve 702). This is controlled by the memory controller 306, 606 for each of the time segments. The consumed bandwidth, as referred to herein, may define the remaining available bandwidth with respect to the maximal possible bandwidth or to a maximal limit of the usable bandwidth.

As illustrated in FIG. 7, time segments (in other words time intervals) of lower usage of the memory bandwidth (limited by the maximum power consumption allowed) are used to proactively write dirty pages to the next memory level and thus, clean the dirty bit on pages such that later, when the pages have to be replaced, they can be paged-out clean faster. The smart paging logic may be in charge of automatically trigger and adjust the pre-cleaning process. This may be implemented as a hardware telemetry-assisted solution.

FIG. 6 shows that the memory controller 606 (e.g., the DMA logic) may be enhanced having the ability to extract D-bits (also referred to as dirty bits indicating modified pages that have to be written back to the higher memory level) out of page tables so that it can correctly determine which pages are dirty, and reset the D-bits as it performs DMA operations. In the event of a race (e.g., if an application writes to a page while the DMA logic is handling the same page)—which may be statistically rare but possible, some pages may be written redundantly because the dirty bit comes on again. However, due to the rarity of these events it may not decrease performance significantly.

According to various aspects, the telemetry used for autonomous smart paging may have, for example, one or more interactions with the software (e.g., with the operating system).

According to various aspects, the memory controller 306, 606 may receive high-level direction from the software so that it illustratively knows which subgroups of page tables and page table entries (PTEs) to scan (and thus avoids needless scanning). Illustratively the memory controller 306, 606 may be configured to receive content information (e.g., content data). Further, the memory controller 306, 606 may be turned on/off by software over selected ranges for selected portions of time.

Further, according to various aspects, the memory controller 306, 606 may receive hints indicating how aggressively it should run. The hints may be dynamic. The hints may be generated range by range.

Further, according to various aspects, the memory controller 306, 606 may provide telemetry data back to the software so that, for example, a smart daemon may guide the hardware to perform its work at the right time over the right ranges, but without doing it in software. A daemon may be a computer program (also referred to as app or application) that runs as a background process in a multitasking operating system. The smart daemon may be configured to run pre-cleaning operations independently from user actions, for example, based on a pre-defined schedule.

Existing software solutions for pre-cleaning may try to clean pages from time to time. For example, a Kernel Swap Daemon (kswapd) in Linux may use a timer and every time it wakes up, the Kernel Swap Daemon may check if the number of free pages is getting too low. If this is the case, the Kernel Swap Daemon may write out some pages of the list of inactive pages (e.g., by default, 4 pages each time it wakes). This may be done regardless of the load on the system, and more aggressive configurations may end up being counterproductive if write backs occur during peak demand intervals. Its design and settings are a vestige of a time, when DRAM capacity was small (so a rate of 4 write backs) and the memory hierarchy was flat, and the disk tier was either old SSDs or even older HDDs (I/O rates in a few hundred to a few thousand I/O operations per second).

In contrast, the memory controller 306, 606 as described herein may be implemented as a hardware solution that automatically pages out dirty pages when the status of the system at a given moment allows a pre-cleaning without interfering the performance of the applications running on the computing system. This may be done using telemetry to know, for example, the bandwidth and the power that is being used on the memory hierarchy at that moment.

The operation of the memory controller 306, 606 described herein may not interfere with existing software solutions. The memory controller 306, 606 may be used together with software solutions in order to improve its efficiency. For example, having the smart paging logic implemented will help keeping a low the number of pages in the list of inactive pages that are also dirty. This will cause software solutions like kswapd not to act unless the smart paging could not provide with enough clean candidates when a replacement is needed.

According to various aspects, the used of the memory controller 306, 606 may not be limited to multi-tiered memory systems, but yields more benefits there due to higher levels of possible interference between paging traffic and normal application caused traffic between CPUs and local/remote memories. This interference may be not limited to the use of memory channels for propagating data but also at CPUs, where software performs various operations to identify and move data from pages in one tier of memory to other tiers.

The memory controller 306, 606 may be used in a software defined infrastructure (SDI) with storage/memory pools (yet another tier), where additional latency and bandwidth costs apply.

According to various aspects, using the memory controller 306, 606 may allow that application-OS responsibility for page-tiering can be refactored and simplified. Today, the ability to remap the same virtual memory to different physical memories may be expensive due to the need to perform synchronous (e.g., global) translation lookside buffer (TLB) shootdowns—thus this sort of remapping may be done infrequently. By keeping page contents in harmony between upper and lower tiers, an application may perform its own lazy TLB shootdowns by coordination internal to the application's algorithms to perform such remapping at much lower cost and much higher agility. All that an application then has to do (assuming the OS is extended to provide external paging as in the MacOS, L4 microkernel, etc.) may be to keep some number of tierl page-frames ready for substituting in place of tier 2+ page-frames, use the memory controller 306, 606 to keep tier 2+ page-frames in sync with any modifications, and then recycle without expensive TLB shootdowns and OS intervention (with application taking responsibility for freezing its own activities over its own subsets of data, during such application managed remapping).

As illustrated in FIG. 6, the smart paging logic may have as inputs the telemetry data coming from each level of the memory hierarchy and the information of the pages in memory (least recently used and their dirty bits). The smart paging logic may be configured with a threshold bandwidth at which the pre-cleaning can be triggered. If the bandwidth falls below the threshold, the bandwidth gap left up to the threshold can be used by the smart paging logic for the pre-cleaning process. The smart paging logic may be configured with power constraints. In this case, the pre-cleaning process may not affect considerably the power consumption of the memory hierarchy in scenarios, where bandwidth could be mostly used by the smart paging logic to pre-clean.

FIG. 8 shows a schematic view of a computing system 800. The computing system 800 may be configured as the computing systems 300, 400, 500, 600, as described before. FIG. 8 shows a data flow related to the different levels of the memory hierarchy 802 and the smart paging logic of the memory controller). According to various aspects, each of the different levels of the memory hierarchy 802 may send regular updates containing telemetry data 802d to the memory controller 806 (e.g., to a DMA controller, e.g., to a DMA acceleration engine) such that the memory controller 806, and the implemented smart paging logic, may have updated information when making a decision associated with a pre-cleaning.

Therefore, the smart paging logic may analyze the status of the system and may adjust the number of pages to write back according the current usage. In the example illustrated in FIG. 8, the smart paging logic may be configured with a bandwidth threshold of 75%. The bandwidth threshold of 75% (as a fraction of the maximal possible or allowed bandwidth) may be used by the memory controller 806 to evaluate whether a pre-cleaning can be carried out or not. The telemetry data 802d may be bandwidth data (e.g., from each of the different memories of the memory hierarchy 802). In the case of a high load 806a (e.g., a load corresponding to a consumed bandwidth that is above the bandwidth threshold), see, for example, the first time segment 700a and the third time segment 700c in FIG. 7, the smart paging logic may decide to not pre-clean any page. Illustratively, based on the telemetry data 802d (e.g., in the case that no or not enough bandwidth is available), the memory controller 806 may remain in the second operation mode or may switch into the second operation mode, as described herein. Therefore, no significant additional data traffic may be generated by the memory controller 806 associated with pre-cleaning.

In the case of a low bandwidth usage 806b, see, for example, the second segment 700b and the fourth time segment 700d in FIG. 7, a fraction of the bandwidth may be available for pre-cleaning. As an example, in the case that 40% of the bandwidth is consumed (e.g., by I/Os from the OS), and the bandwidth threshold is 75%, up to 35% of the bandwidth may be available for the pre-cleaning. In this case, the memory controller 806 may carry out the pre-cleaning. Illustratively, based on the telemetry data 802d (e.g., in the case that at least a pre-defined bandwidth is available), the memory controller 806 may remain in the first operation mode or may switch into the first operation mode, as described herein. According to various aspects, the fraction of the bandwidth that may be actually used for the pre-cleaning may be limited by one or more power constraints. Further, if the bandwidth usage increases 806, the amount of available bandwidth for pre-cleaning is reduced. As an example, in the case that 65% of the bandwidth is consumed (e.g., by I/Os from the OS), and the bandwidth threshold is 75%, up to 10% of the bandwidth may be available for the pre-cleaning.

FIG. 8 illustrates the memory controller 806 in the configuration that bandwidth data from the respective memories 802 may be comparted with a bandwidth threshold of 75%. However, other values may be used for the bandwidth threshold, e.g., less than 75% or greater than 75%.

According to various aspects, telemetry based information may be used to determine when it is [near-] optimal to perform background pre-cleaning or proactive replication. According to various aspects, a software/hardware protocol may be implemented for letting the hardware discover which pages to flush/replicate to which targets. The telemetry is used to coordinate the time periods during which there is sufficient bandwidth, and/or when there is a pronounced shift in application behavior (in reference ratios to upper and lower tiers), so that by performing the new data migration proactively in hardware, it may be easy for a software (including the OS) to perform PTE switching, or for checkpoints to close sooner because critical updates have been replicated between peers, etc. Hints may be considered to go back from hardware to software. A hint may include, for example, an indication that one or more pages have been cleaned and can be recycled.

Various aspects may include bandwidth and power as a possible as telemetry information that could help to drive the hardware, e.g., the memory controller. However, there may be various types of telemetry data being used in this context.

As described above, bandwidth telemetry data may be used to identify one or more intervals of time to start the proactive pre-cleaning of pages. For example, if the memory bandwidth is being underutilized, the exceeding of bandwidth can be used for proactive pre-cleaning of pages without affecting the application's performance.

Further, system on chip (SoC) or computing system power telemetry data may be useful to identify, for example, if one or more other components are being underutilized and the memory is becoming the actual bottleneck. In this case, power may be shifted from the one or more other components, e.g., from the CPU, to the memory and the peak bandwidth may be increased temporarily to perform proactive pre-cleaning without affecting application's performance.

Further, telemetry data associated with access patterns on the different memory levels may be use, according to various aspects. In the case that, for example, an application is accessing a given memory bank, a pre-cleaning on the very same memory bank could interfere. This may affect the latency and/or effective bandwidth of the memory bank. The pre-cleaning, as described herein, may be implemented as a background operation that may be subservient to a foreground usage of the bandwidths. This may be implemented based on a fine time granularity (e.g., in a time interval in the range from about 1 ns to about 1 s) since the scheduling of the cleaning accesses may be under control of hardware, e.g., the memory controller.

According to various aspects, the smart paging logic may not be only bandwidth sensitive; it may back off during times when an instructions per cycle (IPC) indicator is low in ring 3 (a ring of a hierarchical protections domain with the least privileges, e.g., applications), while an average memory latency is high. This may be an indication that CPUs are stalling on memory accesses. This information may be useful as hardware, through telemetry data, may know exactly the access patterns of the application and where they fall to optimize accesses.

According to various aspects, telemetry readings may be carried out at least partially by the memory controller. Further, telemetry readings may be read in a per-defined time interval, e.g., every 1 ms, e.g., every 0.1 ms to 10 ms. The telemetry readings may be asynchronous operations.

According to various aspects, the memory controller may be used to clean dirty pages, which may relieve the one or more processors executing the operating system.

According to various aspects, a hardware pre-clean may be carried out based on telemetry to find the optimal time intervals to make use of the extra bandwidth/power that would be needed perform this operation.

According to various aspects, a memory management system (e.g., a memory controller or one or more processors configured to control a memory hierarchy, as described above) may be provided. The memory management system may include at least a paging logic configured to receive paging data associated with a paging between one or more first memories of a first memory type and one or more second memories of a second memory type, the first memory type being different from the second memory type; receive telemetry data associated with the one or more first memories and the one or more second memories; execute a flush of one or more dirty pages from the one or more first memories to the one or more second memories in a first operation mode, suspend a flush of one or more pages from the one or more first memories to the one or more second memories in a second operation mode, and switch between the first operation mode and the second operation mode based on the telemetry data and the paging data. As described herein, the paging data may include information indicating the one or more dirty pages. The paging data may include information indicating one or more least recently used (LRU) dirty pages of the one or more dirty pages.

According to various aspects, the one or more processors of the memory management system may be further configured to execute the flush of the one or more least recently used dirty pages in the first operation mode; and to switch into the first operation mode only in the case that at least a predefined fraction of a data bandwidth is available to transfer the one or more dirty pages from the one or more first memories to the one or more second memories.

According to various aspects, the telemetry data may include one or more of the following group of data: bandwidth data associated with the one or more first memories; bandwidth data associated with the one or more second memories; latency data associated with the one or more first memories; latency data associated with the one or more second memories; power data associated with the one or more first memories; power data associated with the one or more second memories, power data associated with a computing system hosting the memory management system.

According to various aspects, the one or more processors of the memory management system may be configured to adapt a maximal bandwidth of a data transfer between the one or more first memories and the one or more second memories based on the telemetry data.

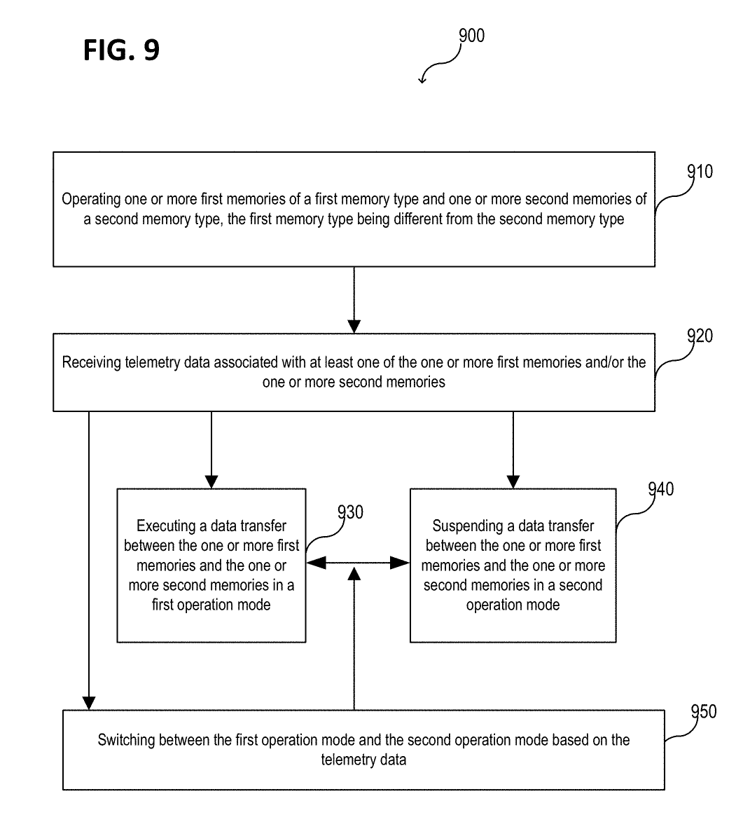

FIG. 9 illustrates a schematic flow diagram of a method 900 for operating a computing system, according to various aspects. The method 900 may be carried out, according to one or more aspects, as described above with reference to the computing system, the memory controller, and/or the smart paging logic, according to various aspects.

According to various aspects, the method 900 may include: in 910, operating one or more first memories of a first memory type and one or more second memories of a second memory type, the first memory type being different from the second memory type; in 920, receiving telemetry data associated with at least one of the one or more first memories and the one or more second memories; in 930, executing a data transfer between the one or more first memories and the one or more second memories in a first operation mode, in 940, suspending a data transfer between the one or more first memories and the one or more second memories in a second operation mode; and, in 950, switching between the first operation mode and the second operation mode based on the telemetry data.

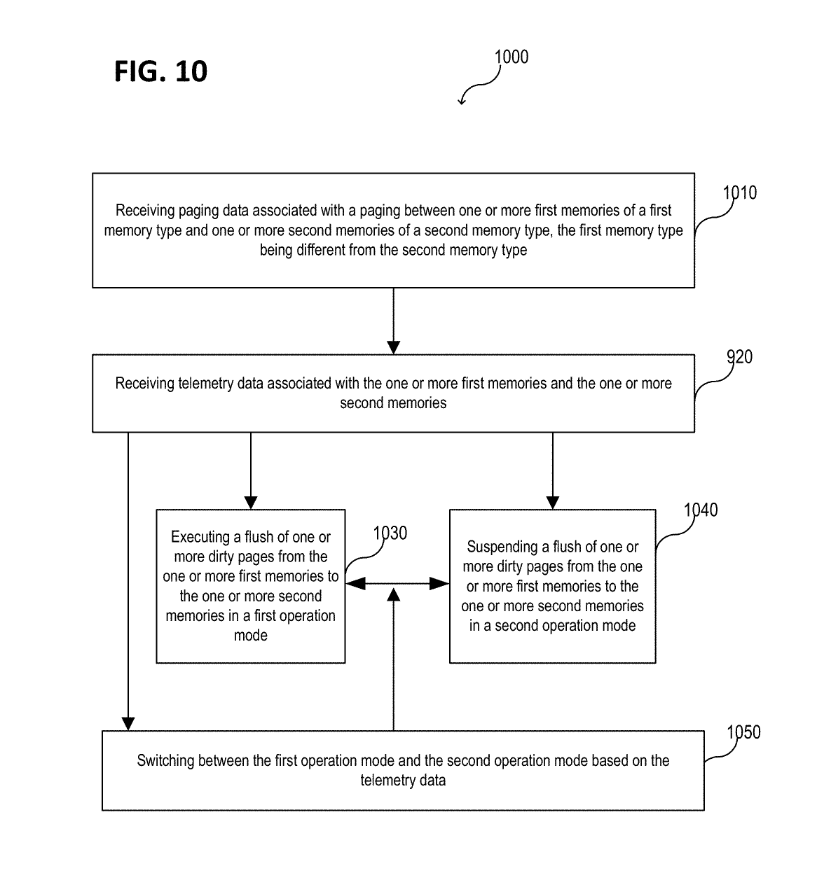

FIG. 10 illustrates a schematic flow diagram of a method 1000 for operating a memory management system (e.g., a memory controller or a logic processor), according to various aspects. The method 1000 may be carried out, according to one or more aspects, as described above with reference to the computing system, the memory controller, and/or the smart paging logic, according to various aspects.

According to various aspects, the method 1000 may include: in 1010, receiving paging data associated with a paging between one or more first memories of a first memory type and one or more second memories of a second memory type, the first memory type being different from the second memory type; in 1020, receiving telemetry data associated with the one or more first memories and the one or more second memories; in 1030, executing a flush of one or more dirty pages from the one or more first memories to the one or more second memories in a first operation mode, in 1040, suspending a flush of one or more dirty pages from the one or more first memories to the one or more second memories in a second operation mode, and, in 1050, switching between the first operation mode and the second operation mode based on the telemetry data.

According to various aspects, the memory controller and/or the smart paging logic, as described herein, may be implemented in a system on chip, a single core processor, a dual core processor, and/or a multicore processor. Illustratively, the memory controller may be used to control different memory types of a CPU.

According to various aspects, a computing system may include: one or more first memories of a first memory type and one or more second memories of a second memory type different from the first memory type; a memory controller configured to receive telemetry data associated with the one or more first memories and the one or more second memories, determine a parameter representing an available bandwidth for a data exchange between the one or more first memories and the one or more second memories based on the telemetry data, and based on a comparison of the parameter with a reference parameter, store and retrieve data from the one or more first memories into the one or more second memories.

According to various aspects, telemetry data may include one or more of the following types of telemetry data: bandwidth related data, power related data, CPU related data. As an example, bandwidth related data may include fabric bandwidth, network interface controller (NIC) read and write bandwidth, I/O read and write bandwidth. Further, telemetry data may be associated with power utilization, read and write latency, CPU utilization, memory utilization.

According to various aspects, the one or more first memories may include first memory cells and the one or more second memories may include second memory cells, wherein the one or more first memory cells may include one or more volatile memory cells and wherein the one or more second memory cells may include one or more non-volatile memory cells.

According to various aspects, the one or more first memories may include first memory cells and the one or more second memories may include second memory cells, wherein the one or more first memory cells may include one or more non-volatile memory cells and wherein the one or more second memory cells may include one or more non-volatile memory cells.

According to various aspects, the one or more first memories may include first memory cells and the one or more second memories may include second memory cells, wherein the one or more first memory cells may include one or more volatile memory cells and wherein the one or more second memory cells may include one or more volatile memory cells.

According to various aspects, telemetry based paging techniques are provided that may be used in heterogeneous memory architectures.

According to various aspects, the memory controller described herein may be configured to operate in a proactive mode to move data based on the telemetry. In the proactive mode, the memory controller may suspend moving data from one memory level to the next memory level based on the telemetry. However, the memory controller may have another operation mode, so that an eviction may be carried out from one memory level to the next memory level independently from the telemetry data, so that the data movement is not suspended in this case.

According to various aspects, a computing system may include: a first memory tier (also referred to as memory level); a second memory tier different from the first memory tier; a memory controller configured to receive telemetry data associated with at least one of the first memory tier or the second memory tier, perform a data transfer between the first memory tier and the second memory tier in a first operation mode of the memory controller, suspend a data transfer between the first memory tier and the second memory tier in a second operation mode of the memory controller, and switch between the first operation mode and the second operation mode based on the telemetry data.

According to various aspects, a computing system may include: a first memory tier (also referred to as level); a second memory tier different from the first memory tier; a memory controller configured to receive telemetry data associated with at least one of the first memory tier or the second memory tier, proactively perform a data transfer between the first memory tier and the second memory tier based on the telemetry data.

In the following, various examples are provided with reference to the aspects described above.

Example 1 is a computing system. The computing system may include one or more first memories of a first memory type, one or more second memories of a second memory type different from the first memory type, a memory controller configured to receive telemetry data associated with at least one of the one or more first memories or the one or more second memories, to perform a data transfer between the one or more first memories and the one or more second memories in a first operation mode of the memory controller, to suspend a data transfer between the one or more first memories and the one or more second memories in a second operation mode of the memory controller, and to switch between the first operation mode and the second operation mode based on the telemetry data.

In Example 2, the subject matter of Example 1 can optionally include that the memory controller is further configured to receive memory management data associated with a memory management scheme.

In Example 3, the subject matter of Example 2 can optionally include that the memory controller is further configured to perform the data transfer based on the received memory management data.

In Example 4, the subject matter of any one of Examples 2 or 3 can optionally include that the memory management scheme includes a paging scheme and that the memory management data include paging data.

In Example 5, the subject matter of Example 4 can optionally include that the paging data include information indicating one or more dirty pages.

In Example 6, the subject matter of Example 5 can optionally include that the data transfer includes a flushing of the one or more dirty pages from the one or more first memories to the one or more second memories.

In Example 7, the subject matter of any one of Examples 4 to 6 can optionally include that the paging data include information indicating one or more least recently used pages.

In Example 8, the subject matter of any one of Examples 2 to 7 can optionally include that the memory controller is further configured to update the memory management data associated with the memory management scheme.

In Example 9, the subject matter of Example 8 can optionally include that updating the memory management data includes changing a dirty bit associated with a page associated with the memories.

In Example 10, the subject matter of any one of Examples 2 to 9 can optionally include that the computing system further includes a memory management controller configured to perform the memory management and to generate the memory management data.

In Example 11, the subject matter of any one of Examples 1 to 10 can optionally include that the computing system further includes one or more processors configured to generate the telemetry data.

In Example 12, the subject matter of any one of Examples 1 to 11 can optionally include that the telemetry data include at least one of first bandwidth data associated with the one or more first memories or second bandwidth data associated with the one or more second memories.

In Example 13, the subject matter of Example 12 can optionally include that the memory controller is configured to compare at least one of the first bandwidth data or the second bandwidth data with corresponding bandwidth reference data and, based on the comparison, to switch between the first operation mode and the second operation mode based on the comparison result.

In Example 14, the subject matter of Example 13 can optionally include that the memory controller is configured to switch into the first operation mode in case that at least a predefined fraction of a data bandwidth is available to transfer data between the one or more first memories and the one or more second memories.

In Example 15, the subject matter of Example 14 can optionally include that the memory controller is further configured to switch into the second operation mode in case that at least the predefined fraction of the data bandwidth is not available.

In Example 16, the subject matter of any one of Examples 1 to 15 can optionally include that the telemetry data include at least one of first latency data associated with the one or more first memories and second latency data associated with the one or more second memories.

In Example 17, the subject matter of any one of Examples 1 to 16 can optionally include that the computing system further includes one or more processors configured to execute an operating system having access to the one or more first memories and the one or more second memories.

In Example 18, the subject matter of Example 17 can optionally include that the telemetry data include power data associated with at least one of a load or a power consumption of the one or more processors configured to execute the operating system.

In Example 19, the subject matter of any one of Examples 1 to 18 can optionally include that the memory controller is configured to adapt a maximal bandwidth of a data transfer between the one or more first memories and the one or more second memories based on the telemetry data.

In Example 20, the subject matter of any one of Examples 1 to 19 can optionally include that the memory controller is configured to receive an activation information indicating whether or not an activation of the first operation mode is allowed.

In Example 21, the subject matter of any one of Examples 1 to 20 can optionally include that the memory controller is configured to receive an operation information associated with the switching between the first operation mode and the second operation mode.

In Example 22, the subject matter of any one of Examples 1 to 21 can optionally include that the operation information indicates an access pattern to at least one of the one or more first memories or the one or more second memories.

In Example 23, the subject matter of any one of Examples 1 to 22 can optionally include that the memory controller is configured to receive content information associated with the data transfer performed in the first operation mode.

In Example 24, the subject matter of any one of Examples 1 to 23 can optionally include that the memory controller is configured to perform the data transfer autonomously.

In Example 25, the subject matter of any one of Examples 1 to 24 can optionally include that the memory controller is configured to perform the data transfer by a direct access to the one or more first memories and the one or more second memories.

In Example 25, the subject matter of any one of Examples 1 to 25 can optionally include that the one or more first memories include one or more volatile memories and the one or more second memories include one or more non-volatile memories.

In Example 27, the subject matter of any one of Examples 1 to 25 can optionally include that the one or more first memories include one or more volatile memories and the one or more second memories include one or more volatile memories.

In Example 28, the subject matter of any one of Examples 1 to 25 can optionally include that the one or more first memories include one or more non-volatile memories and the one or more second memories include one or more non-volatile memories.

In Example 29, the subject matter of any one of Examples 1 to 28 can optionally include that the one or more first memories include a first maximal data bandwidth and wherein the one or more second memories include a second maximal data bandwidth; the first maximal data bandwidth being greater than the second maximal data bandwidth.

In Example 30, the subject matter of any one of Examples 1 to 28 can optionally include that the computing system further includes one or more third memories of a third memory type, the third memory type being different from the first memory type and the second memory type.

In Example 31, the subject matter of Example 30 can optionally include that the one or more first memories include a first maximal data bandwidth, the one or more second memories include a second maximal data bandwidth, and the one or more third memories include a third maximal data bandwidth. The first maximal data bandwidth is greater than the second maximal data bandwidth and the second maximal data bandwidth is greater than the third maximal data bandwidth.

In Example 32, the subject matter of any one of Examples 30 to 31 can optionally include that the computing system further includes one or more fourth memories of a fourth memory type, the fourth memory type being different from the first memory type, the second memory type, and the third memory type.

In Example 33, the subject matter of Example 32 can optionally include that the one or more first memories include a first maximal data bandwidth, the one or more second memories include a second maximal data bandwidth, the one or more third memories include a third maximal data bandwidth, and the one or more fourth memories include a fourth maximal data bandwidth. The first maximal data bandwidth is greater than the second maximal data bandwidth, the second maximal data bandwidth is greater than the third maximal data bandwidth, and the third maximal data bandwidth is greater than the fourth maximal data bandwidth.

Example 34 is a memory management system. The memory management system may include a paging logic configured to receive paging data associated with a paging between one or more first memories of a first memory type and one or more second memories of a second memory type, the first memory type being different from the second memory type, to receive telemetry data associated with the one or more first memories and the one or more second memories, and to execute a flush of one or more dirty pages from the one or more first memories to the one or more second memories in a first operation mode, to suspend a flush of one or more pages from the one or more first memories to the one or more second memories in a second operation mode, and to switch between the first operation mode and the second operation mode based on the telemetry data and the paging data.

In Example 35, the subject matter of Example 34 can optionally include that the paging data include information indicating the one or more dirty pages.

In Example 36, the subject matter of any one of Examples 34 or 35 can optionally include that the paging data include information indicating one or more least recently used dirty pages of the one or more dirty pages.

In Example 37, the subject matter of Example 36 can optionally include that the paging logic is further configured to execute the flush of the one or more least recently used dirty pages in the first operation mode.

In Example 38, the subject matter of any one of Examples 34 to 37 can optionally include that the paging logic is configured to switch into the first operation mode only in the case that at least a predefined fraction of a data bandwidth is available to transfer the one or more dirty pages from the one or more first memories to the one or more second memories.

In Example 39, the subject matter of any one of Examples 34 to 38 can optionally include that the telemetry data include at least one of the following group of data: bandwidth data associated with the one or more first memories; bandwidth data associated with the one or more second memories; latency data associated with the one or more first memories; latency data associated with the one or more second memories; power data associated with the one or more first memories; power data associated with the one or more second memories.

In Example 40, the subject matter of any one of Examples 34 to 39 can optionally include that the paging logic is configured to adapt a maximal bandwidth of a data transfer between the one or more first memories and the one or more second memories based on the telemetry data.

Example 41 is a method for operating a computing system. The method may include operating one or more first memories of a first memory type and one or more second memories of a second memory type different from the first memory type, receiving telemetry data associated with at least one of the one or more first memories or the one or more second memories, executing a data transfer between the one or more first memories and the one or more second memories in a first operation mode, suspending a data transfer between the one or more first memories and the one or more second memories in a second operation, and switching between the first operation mode and the second operation mode based on the telemetry data.

In Example 42, the subject matter of Example 41 can optionally include that the method further includes receiving memory management data associated with a memory management scheme.

In Example 43, the subject matter of Example 42 can optionally include that the method further includes executing the data transfer based on the received memory management data.

In Example 44, the subject matter of any one of Examples 42 or 43 can optionally include that the memory management scheme includes a paging scheme and that the memory management data include paging data.

In Example 45, the subject matter of Example 44 can optionally include that the paging data include information indicating one or more dirty pages.

In Example 46, the subject matter of Example 45 can optionally include that executing a data transfer includes flushing the one or more dirty pages from the one or more first memories to the one or more second memories.

In Example 47, the subject matter of any one of Examples 44 to 46 can optionally include that the paging data include information indicating one or more least recently used pages.

In Example 48, the subject matter of any one of Examples 42 to 47 can optionally include that the method further includes updating the memory management data associated with the memory management scheme.

In Example 49, the subject matter of Example 48 can optionally include that updating the memory management data includes changing a dirty bit associated with a page.

In Example 50, the subject matter of any one of Examples 42 to 49 can optionally include that the method further includes generating the memory management data.

In Example 51, the subject matter of any one of Examples 42 to 50 can optionally include that the method further includes generating the telemetry data.

In Example 52, the subject matter of any one of Examples 41 to 51 can optionally include that the telemetry data include at least one of first bandwidth data associated with the one or more first memories or second bandwidth data associated with the one or more second memories.

In Example 53, the subject matter of Example 52 can optionally include that the method further includes comparing at least one of the first bandwidth data or the second bandwidth data with corresponding bandwidth reference data and, based on the comparison, and switching between the first operation mode and the second operation mode.

In Example 54, the subject matter of Example 53 can optionally include that the method further includes switching into the first operation mode in the case that at least a predefined fraction of a data bandwidth is available to transfer data between the one or more first memories and the one or more second memories.

In Example 55, the subject matter of Example 54 can optionally include that the method further includes switching into the second operation mode in the case that at least the predefined fraction of the data bandwidth is not available.

In Example 56, the subject matter of any one of Examples 41 to 55 can optionally include that the telemetry data include at least one of first latency data associated with the one or more first memories and second latency data associated with the one or more second memories.

In Example 57, the subject matter of any one of Examples 41 to 56 can optionally include that the method further includes executing an operating system having access to the one or more first memories and the one or more second memories.

In Example 58, the subject matter of Example 57 can optionally include that the telemetry data include power data associated with at least one of a load or a power consumption of one or more processors configured to execute the operating system.

In Example 59, the subject matter of any one of Examples 41 to 58 can optionally include that the method further includes adapting a maximal bandwidth of a data transfer between the one or more first memories and the one or more second memories based on the telemetry data.

In Example 60, the subject matter of any one of Examples 41 to 59 can optionally include that the method further includes receiving an activation information indicating whether or not an activation of the first operation mode is allowed.

In Example 61, the subject matter of any one of Examples 41 to 60 can optionally include that the method further includes receiving an operation information associated with the switching between the first operation mode and the second operation mode.

In Example 62, the subject matter of Example 61 can optionally include that the operation information indicating an access pattern to at least one of the one or more first memories or the one or more second memories.

In Example 63, the subject matter of any one of Examples 41 to 62 can optionally include that the method further includes receiving content information associated with the data transfer executed in the first operation mode.

In Example 64, the subject matter of any one of Examples 41 to 63 can optionally include that the method further includes executing the data transfer autonomously from an operating system.

In Example 65, the subject matter of any one of Examples 41 to 64 can optionally include that the method further includes executing the data transfer by a direct access to the one or more first memories and the one or more second memories.

In Example 66, the subject matter of any one of Examples 41 to 65 can optionally include that the one or more first memories include one or more volatile memories and the one or more second memories include one or more non-volatile memories.

In Example 67, the subject matter of any one of Examples 41 to 65 can optionally include that the one or more first memories include one or more volatile memories and the one or more second memories include one or more volatile memories.

In Example 68, the subject matter of any one of Examples 41 to 65 can optionally include that the one or more first memories include one or more non-volatile memories and the one or more second memories include one or more non-volatile memories.

In Example 69, the subject matter of any one of Examples 41 to 68 can optionally include that the one or more first memories include a first maximal data bandwidth and that the one or more second memories include a second maximal data bandwidth; the first maximal data bandwidth being greater than the second maximal data bandwidth.

Example 70 is a method for operating a memory management system. The method may include receiving paging data associated with a paging between one or more first memories of a first memory type and one or more second memories of a second memory type, the first memory type being different from the second memory type, receiving telemetry data associated with the one or more first memories and the one or more second memories, executing a flush of one or more dirty pages from the one or more first memories to the one or more second memories in a first operation mode, suspending a flush of one or more dirty pages from the one or more first memories to the one or more second memories in a second operation mode, and switching between the first operation mode and the second operation mode based on the telemetry data.

In Example 71, the subject matter of Example 70 can optionally include that the paging data include information indicating the one or more dirty pages.

In Example 72, the subject matter of any one of Examples 70 or 71 can optionally include that the paging data include information indicating one or more least recently used dirty pages of the one or more dirty pages.

In Example 73, the subject matter of Example 72 can optionally include that the method further includes executing the flush of the one or more least recently used dirty pages in the first operation mode.

In Example 74, the subject matter of any one of Examples 70 to 73 can optionally include that the method further includes switching into the first operation mode only in the case that at least a predefined fraction of a data bandwidth is available to transfer the one or more dirty pages from the one or more first memories to the one or more second memories.

In Example 75, the subject matter of any one of Examples 70 to 74 can optionally include that the telemetry data include at least one of the following group of data: bandwidth data associated with the one or more first memories, bandwidth data associated with the one or more second memories, latency data associated with the one or more first memories, latency data associated with the one or more second memories, power data associated with the one or more first memories, power data associated with the one or more second memories, power data associated with a computing system.

In Example 76, the subject matter of any one of Examples 70 to 75 can optionally include that the method further includes adapting a maximal bandwidth of a data transfer between the one or more first memories and the one or more second memories based on the telemetry data.

Example 77 is a non-transitory computer readable medium storing instructions that when executed by a processor cause the processor to perform the method according to any one of Examples 41 to 76.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

What is claimed is:

1. A computing system, comprising:
one or more first memories of a first memory type;
one or more second memories of a second memory type different from the first memory type;
a memory controller configured to
receive telemetry data associated with at least one of the one or more first memories or the one or more second memories,
perform a data transfer between the one or more first memories and the one or more second memories in a first operation mode of the memory controller,
suspend a data transfer between the one or more first memories and the one or more second memories in a second operation mode of the memory controller, and
switch between the first operation mode and the second operation mode based on the telemetry data.

2. The computing system of claim 1,
wherein the memory controller is further configured to receive memory management data associated with a memory management scheme.

3. The computing system of claim 2,
wherein the memory controller is further configured to perform the data transfer based on the received memory management data.

4. The computing system of claim 2,
wherein the memory management scheme comprises a paging scheme and wherein the memory management data comprise paging data.

5. The computing system of claim 2, further comprising:
a memory management controller configured to perform the memory management and to generate the memory management data.

6. The computing system of claim 1, further comprising:
one or more processors configured to generate the telemetry data.

7. The computing system of claim 1,
wherein the telemetry data comprise at least one of first bandwidth data associated with the one or more first memories or second bandwidth data associated with the one or more second memories.

8. The computing system of claim 7,
wherein the memory controller is configured to
compare at least one of the first bandwidth data or the second bandwidth data with corresponding bandwidth reference data and, based on the comparison,
switch between the first operation mode and the second operation mode based on the comparison result.

9. The computing system of claim 1,
wherein the telemetry data comprise at least one of first latency data associated with the one or more first memories and second latency data associated with the one or more second memories.

10. The computing system of claim 1, further comprising:
one or more processors configured to execute an operating system having access to the one or more first memories and the one or more second memories.

11. The computing system of claim 10,
wherein the telemetry data comprise power data associated with at least one of a load or a power consumption of the one or more processors configured to execute the operating system.

12. The computing system of claim 1,
wherein the memory controller is configured to adapt a maximal bandwidth of a data transfer between the one or more first memories and the one or more second memories based on the telemetry data.

13. The computing system of claim 1,
wherein the memory controller is configured to receive an operation information associated with the switching between the first operation mode and the second operation mode.

14. The computing system of claim 13,
the operation information indicating an access pattern to at least one of the one or more first memories or the one or more second memories.

15. A memory management system, comprising:
a paging logic configured to
receive paging data associated with a paging between one or more first memories of a first memory type and one or more second memories of a second memory type, the first memory type being different from the second memory type;
receive telemetry data associated with the one or more first memories and the one or more second memories;
execute a flush of one or more dirty pages from the one or more first memories to the one or more second memories in a first operation mode,
suspend a flush of one or more pages from the one or more first memories to the one or more second memories in a second operation mode, and
switch between the first operation mode and the second operation mode based on the telemetry data and the paging data.

16. The memory management system of claim 15,
wherein the paging data comprise information indicating one or more least recently used dirty pages of the one or more dirty pages.

17. The memory management system of claim 15,
wherein the telemetry data comprise at least one of the following group of data:
bandwidth data associated with the one or more first memories;
bandwidth data associated with the one or more second memories;
latency data associated with the one or more first memories;
latency data associated with the one or more second memories;
power data associated with the one or more first memories;
power data associated with the one or more second memories.

18. The memory management system of claim 15,
wherein the paging logic is configured to adapt a maximal bandwidth of a data transfer between the one or more first memories and the one or more second memories based on the telemetry data.

19. A method for operating a computing system, the method comprising:
operating one or more first memories of a first memory type and one or more second memories of a second memory type different from the first memory type;
receiving telemetry data associated with at least one of the one or more first memories or the one or more second memories,
executing a data transfer between the one or more first memories and the one or more second memories in a first operation mode,
suspending a data transfer between the one or more first memories and the one or more second memories in a second operation mode, and
switching between the first operation mode and the second operation mode based on the telemetry data.

20. The method of claim 19, further comprising:
switching into the first operation mode in the case that at least a predefined fraction of a data bandwidth is available to transfer data between the one or more first memories and the one or more second memories.
